(19) United States
(12) Patent Application Publication
(10) Pub. No.: US 2016/0035026 A1
(43) Pub. Date: Feb. 4, 2016

(54) ONLINE TRADING SYSTEMS AND METHODS

(71) Applicant: Hitrader Technology Limited, West Bay, KY (US)

(72) Inventor: Puhai Chen, Shanghai (CN)

(73) Assignee: Hitrader Technology Limited

(21) Appl. No.: 14/449,294

(22) Filed: Aug. 1, 2014

(51) Int. Cl. G06Q 40/04

(52) U.S. Cl. CPC G06Q 40/04

(57) ABSTRACT

The present disclosure relates to methods and systems for online trading. Embodiments of the disclosure may retrieve transaction data indicating trading activities associated with a first user and estimate a winning probability of a future trade to be made by the first user based on the transaction data. Some embodiments may also present the winning probability to a second user and receive a following order from the second user to follow the future trade of the first user. In addition, some embodiments may associate the following order with the first user and detect a triggering order placed by the first user. The triggering order may include a trading characteristic associated with the winning probability. Moreover, some embodiments may execute the following order in synchronization with execution of the triggering order.

### TECHNICAL FIELD

This disclosure relates generally to online trading. More specifically, it relates to Terminal-to-Terminal trading systems and methods that synchronize trading transactions based on winning probability estimations.

### BACKGROUND

In traditional online trading models, a trader can research the market, analyze various information, and make trading decision based on his/her own research and analysis. The trader may consult another, more experienced trader with questions, but lacks the ability to follow exactly how the more experienced trader reacts to market changes.

Certain techniques have been proposed to follow every move of a more experience trader, no matter what type of trading or what kind of product is involved. However, a trader experienced in one type of trading (e.g., foreign currency exchange—FOREX) may not have the same level of experience in another type of trading (e.g., stock), or the trader may have access to more information, and therefore make have a better chance to profit in one area of trading (e.g., energy section stocks or EUR to USD exchange) than another area of trading (e.g., hi-tech section stocks or GBP to NZD exchange). Thus, such blind following may not yield optimal trading result.

Therefore, it is desirable to develop a more precise and flexible trade following technique to maximize investment returns from trade following.

### SUMMARY

Certain embodiments of the present disclosure relate to a computer-implemented trading method. The method may comprise retrieving transaction data indicating trading activities associated with a first user and estimating a winning probability of a future trade to be made by the first user based on the transaction data. The method may also comprise presenting the winning probability to a second user and receiving a following order from the second user to follow the future trade of the first user. In addition, the method may comprise associating the following order with the first user and detecting a triggering order placed by the first user. The triggering order may include a trading characteristic associated with the winning probability. Moreover, the method may comprise executing the following order in synchronization with execution of the triggering order.

Certain embodiments of the present disclosure also relate to a trading system. The trading system may comprise a processor device operatively coupled to a memory device. The processor device may be configured to execute instructions stored in the memory device to perform operations. The operations may comprise retrieving transaction data indicating trading activities associated with a first user and estimating a winning probability of a future trade to be made by the first user based on the transaction data. The operations may also comprise presenting the winning probability to a second user and receiving a following order from the second user to follow the future trade of the first user. In addition, the operations may comprise associating the following order with the first user and detecting a triggering order placed by the first user. The triggering order may include a trading characteristic associated with the winning probability. Moreover, the operations may comprise executing the following order in synchronization with execution of the triggering order.

Certain embodiments of the present disclosure also relate to a non-transitory, computer-readable medium storing instructions that, when executed by a processor device, cause the processor device to perform operations. The operations may comprise retrieving transaction data indicating trading activities associated with a first user and estimating a winning probability of a future trade to be made by the first user based on the transaction data. The operations may also comprise presenting the winning probability to a second user and receiving a following order from the second user to follow the future trade of the first user. In addition, the operations may comprise associating the following order with the first user and detecting a triggering order placed by the first user. The triggering order may include a trading characteristic associated with the winning probability. Moreover, the operations may comprise executing the following order in synchronization with execution of the triggering order.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 illustrates an exemplary online trading system, according to some embodiments of the present disclosure.

FIG. 2 illustrates an exemplary Terminal-to-Terminal trading system, according to some embodiments of the present disclosure.

FIG. 3A illustrates an exemplary odds following process, according to some embodiments of the present disclosure.

FIG. 3B illustrates another exemplary odds following process, according to some embodiments of the present disclosure.

FIG. 3C is a block diagram of an exemplary risk management module, according to some embodiments of the present disclosure.

FIG. 4 illustrates an exemplary computer system for implementing methods and systems consistent with the present disclosure.

FIG. 5 is a flowchart of an exemplary online trading method, according to some embodiments of the present disclosure.

FIG. 6 illustrates an exemplary table for presenting trading information, according to some embodiments of the present disclosure.

FIG. 7 illustrates an exemplary odds searching process, according to some embodiments of the present disclosure.

FIG. 8 illustrates an exemplary table for presenting winning probabilities, according to some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It is also noted that as used herein and in the appended claims, the singular forms “a,” “an,” and “the” include plural references unless the context clearly dictates otherwise.

The present application discloses systems and methods for Terminal-to-Terminal (T2T) online trading. The term “Terminal-to-Terminal” refers to a trading method in which one trader's trading terminal may follow another trader's trading terminal. In particular, the present application involves following a specific future order of a trader based on an estimation of the winning probability of that specific future order.

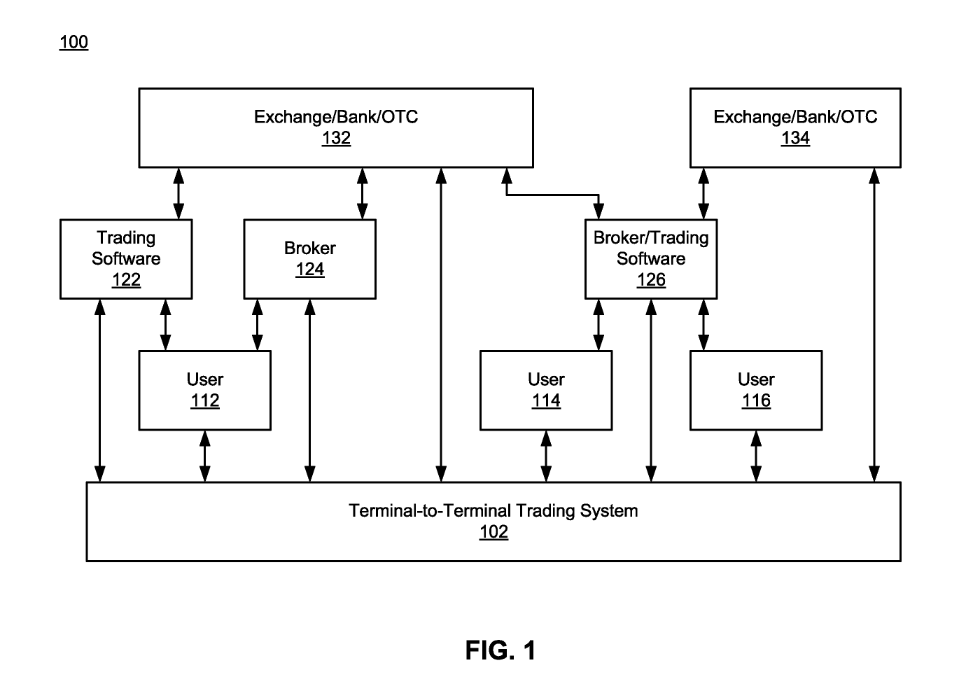

FIG. 1 illustrates an exemplary online trading system 100. As shown in FIG. 1, online trading system 100 may include a T2T trading system 102, a plurality of users (112, 114, 116), brokers (124, 126) and/or trading software (122, 126) used by the users to trade financial products at one or more exchanges, banks, or over-the-counter markets (OTCs) (132, 134). As used herein, a user may also be referred to as a trader; T2T trading system 102 may be referred to as trading system 102 or system 102 for simplicity. An exchange/bank/OTC may be referred to an exchange for simplicity.

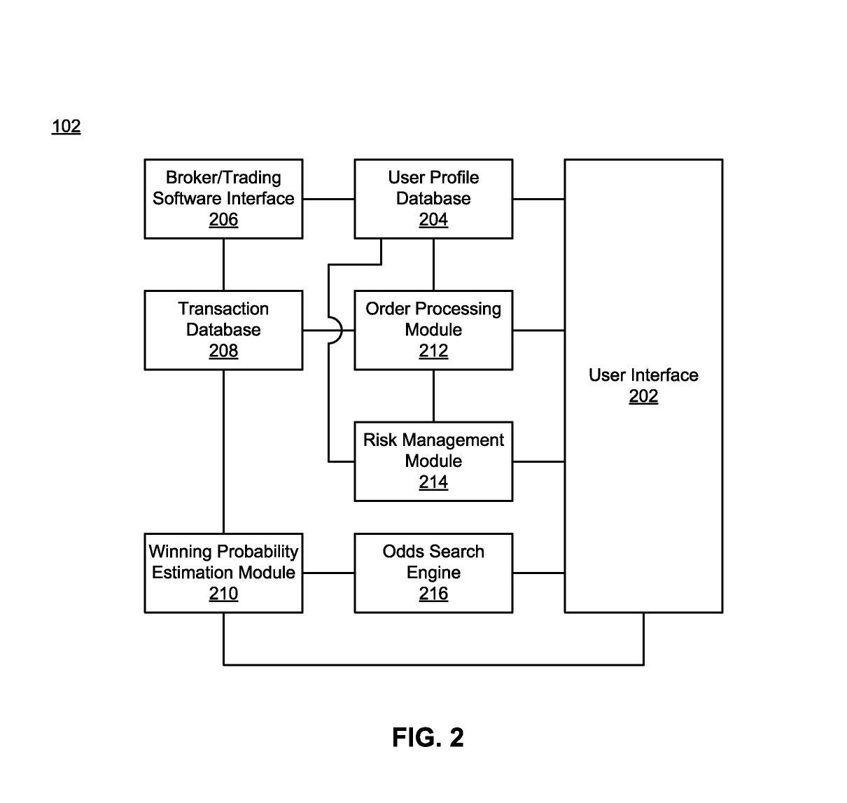

FIG. 2 illustrates an exemplary implementation of trading system 102. As shown in FIG. 2, trading system 102 may include a user interface 202, a user profile database 204, a broker/trading software interface 206, a transaction database 208, a winning probability estimation module 210, an order processing module 212, a risk management module 214, and an odds search engine 216.

In some embodiments, a user (e.g., 112, 114, or 116) may register to the services of trading system 102. For example, the user may access a user interface 202 provided by trading system 102, such as a website, and create a user profile. The user profile may be saved in user profile database 204. The user profile may include a user identification, contact information, financial information, etc. The financial information may include access information to the user's trading account. In some embodiments, the trading account may include the user's brokerage account. In some embodiments, the trading account may include the user's trading software account. For example, as shown in FIG. 1, user 112 may register to trading system 102 and provide access information to his/her brokerage account with broker 124 and trading software account with trading software 122. After authorized by user 112, trading system 102 may access to these trading accounts of user 112 through broker/trading software interface 206. Similarly, users 114 and 116 may register to trading system 102 and authorize trading system 102 to access to their trading accounts with broker or trading software 126 through broker/trading software interface 206.

In some embodiments, a user may also conduct trading directly on trading system 102. For example, user 112 may place an order on trading system 102 through user interface 202 and order processing module 212. Trading system 102 may then submit and execute the order (e.g., using broker/trading software interface 206) in a proper exchange through broker 124 and/or trading software 122 on behalf of user 112.

In some embodiments, trading system 102 may function as a broker or trading software that directly interact with exchanges 132 and/or 134. In this case, an order placed by a user may be submitted directly to a proper exchange without passing through a third party broker or trading software.

A user may trade different types of financial product on trading system 102. For example, user 114 may trade currency (e.g., FOREX), stock, bond, commodity, future, option, derivatives, or other types of financial product on trading system 102. User 114 may provide to trading system 102 with information of multiple trading accounts corresponding to different types of financial product, or information of a trading account capable of trading multiple types of financial product. As an example, exchange 132 in FIG. 1 may be a foreign currency exchange or a FOREX trading system (e.g., OTC market), while exchange 134 may be a stock exchange. It is noted that although FIG. 1 includes a single box for each exchange, this is for illustrative purpose only and only for indicating that exchanges 132 and 134 may be for trading different types of financial product. It is noted that even for trading the same type of financial product, such as FOREX or stock, multiple exchanges may exist and may be located in different geographical regions. In some cases, trading of financial products may even be conducted in a distributed manner without a centralized exchange. Therefore, exchanges 132 and 134 in FIG. 1 should be understood as a logical collection of necessary resources for trading a particular type of financial product. The T2T trading concept disclosed herein is applicable regardless of the particular form of implementing the exchanges.

After gaining access to a user's trading account (with a broker and/or with trading software), trading system 102 may retrieve transaction data indicating trading activities associated with the user from the trading account using broker/trading software interface 206. The transaction data may include a history of trading transactions. For example, the transaction data may include information such as the trading date/time, the financial product that was traded, the buying/selling price, the number of shares or the amount traded, the gain/loss information, etc. In some embodiment, such transaction data may be maintained by the broker of the user. For example, broker 124 may store historical transaction data of user 112 in a database accessible to user 112. In this case, trading system may, after authorized by used 112, use broker/trading software interface 206 to access the database and retrieve the transaction data electronically using a standard or customized financial data exchange protocol. In another example, the transaction data may be contained in financial statements stored in an electronic format, such as PDF, CVS, etc. on the broker's server. In this case, trading system 102 may use broker/trading software interface 206 to download the financial statements and extract the transaction data from the financial statements. In some embodiments, trading system 102 may use broker/trading software interface 206 to monitor the information flow of trading software 122 and retrieve transaction data from the information flow. For example, trading system 102 may use broker/trading software interface 206 to monitor the trade/order information exchanged between trading software 122 and exchange 132 with respect to user 112 and extract transaction data from the trade/order information. The retrieved transaction data may be stored in transaction database 208.

In some embodiments, trading system 102 may retrieve transaction data including a history of trading transactions made by user 112 from broker 124 and/or trading software 122. The history of trading transactions may include orders for buying/selling one or more types of financial product (also referred to as trading types), such as currency (e.g., FOREX), stock, bond, commodity, future, option, derivatives, etc. The orders may also include one or more financial products (also referred to as trading products) under each trading type. For example, trading orders of foreign currencies may include particular currency exchanges such as exchange from EUR to USD (EURUSD), from GBP to USD (GBPUSD), from EUR to NZD (EURNZD), from USD to EUR (USDEUR), etc. In another example, trading orders of stocks may include particular stocks such as buying IBM, selling MSFT, etc. Winning probability estimation module 210 may identify transaction data that associated with a particular user, a particular trading type, a collection of trading products, and/or a particular trading product, and use the identified subset of transaction data to estimate a winning probability.

A winning probability may indicate the likelihood that a profit level resulting from a future trade to be made by a user is higher than a predetermined threshold. For example, a winning probability may be in the form of a percentage value that indicates, for example, there is a 80% likelihood that user 112 will make a profit of at least 7% from his/her next trade of foreign currency exchange, and in particular, exchange from EUR to USD. In another example, a winning probability may indicate a probability that user 112 will make a profitable trade (e.g., with a positive gain) resulting from his/her next buying or selling order of a particular type of financial product (e.g., FOREX, stock, bond, etc.), of a particular collection of financial products (e.g., energy section stocks), or of a particular financial product (e.g., buying or selling IBM).

Winning probability estimation module 210 may use various algorithms to estimate the winning probability based on the transaction data or a subset of the transaction data. For example, one such algorithm includes calculating a user's weighted winning percentage for trading a certain collection of financial products based on historical transaction data. The collection of financial products may include the entire transaction history of the user, or may include a subset of the transaction history based on the trading type, the trading product, or a portfolio of several trading products. The weighting factor may include the age of the trading transaction (e.g., older transaction may be assigned less weights), the amount of capital involved in the trading transaction (e.g., larger amount may be assigned more weights), the similarity of the trading transaction to the future trade (e.g., if the wining probability is about a future currency exchange, then a past currency exchange transaction may be assigned more weights than a past stock trading transaction), the number of trading transactions (e.g., may indicate whether the user is a frequent trader), the length of trading history (e.g., may indicate whether the user is a newbie or a veteran), or other relevant factors that may reflect the experience of the user.

After a wining probability of a future trade is estimated by winning probability estimation module 210, the winning probability may be presented to a user through user interface 202. For example, referring to FIG. 1, a winning probability of user 112's next trade of EURUSD (exchanging EUR to USD) may be estimated and presented to users 114 and 116. User 114 may then wish to follow user 112's next trade of EURUSD. User 114 may submit a following order to trading system 102 to follow user 112's next trade. The following order may be specified by user 114, for example, to indicate the amount of currency to be traded, a tolerance level of loss, etc. The following order may also be preset by user 114 and saved to user 114's user profile (e.g., in user profile database 204), such that when user 114 wishes to follow user 112, user 114 may simply indicate his wish by clicking a button or the like, and order processing module 212 may automatically placing the preset order based on information stored in user profile database 204. In another example, user 114 may indicate his risk tolerance level. The risk tolerance information may be stored and analyzed by risk management module 214. Order processing module may then place a proper following order based on the risk analysis performed by risk management module 214. Risk management module 214 will be described in greater detail later.

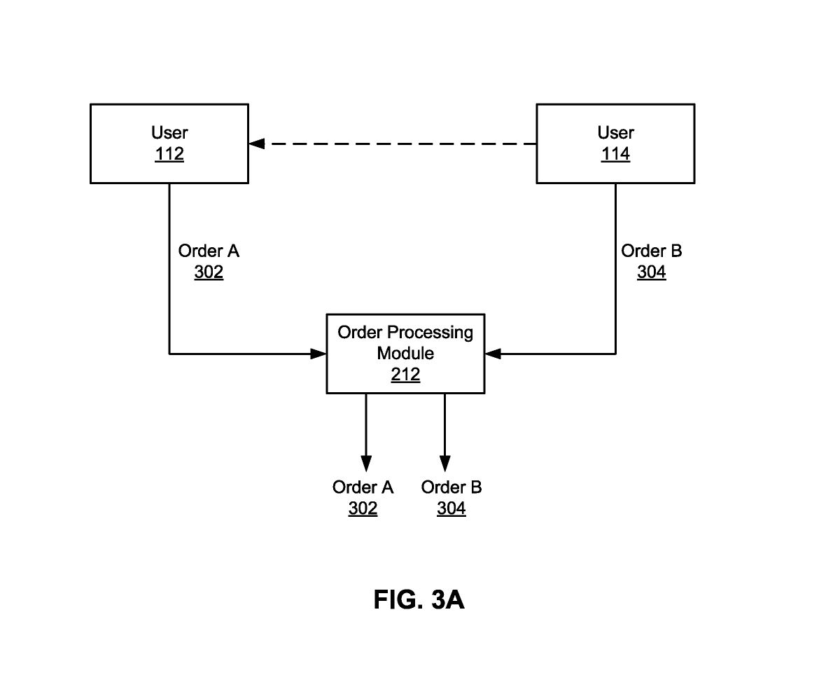

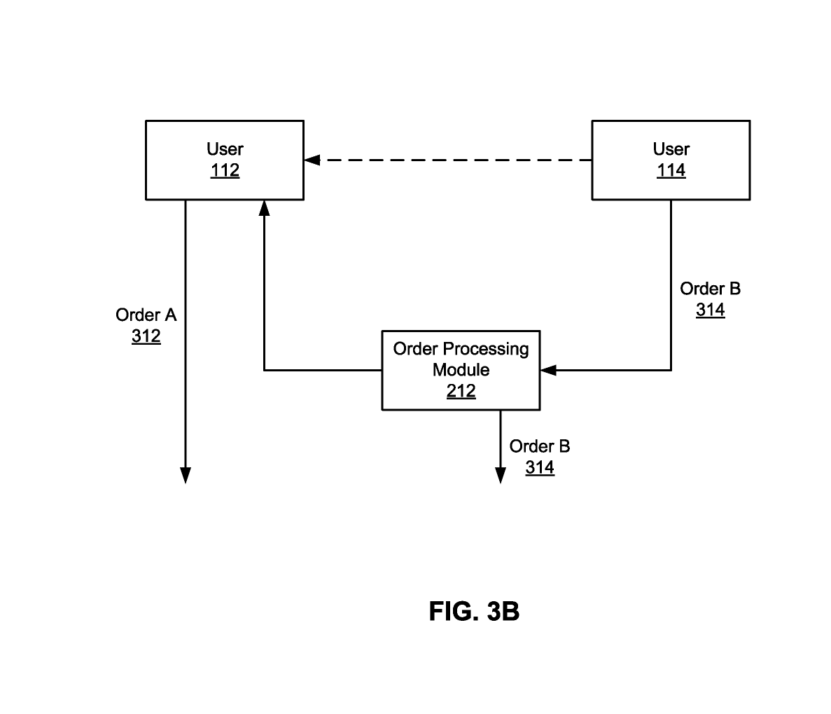

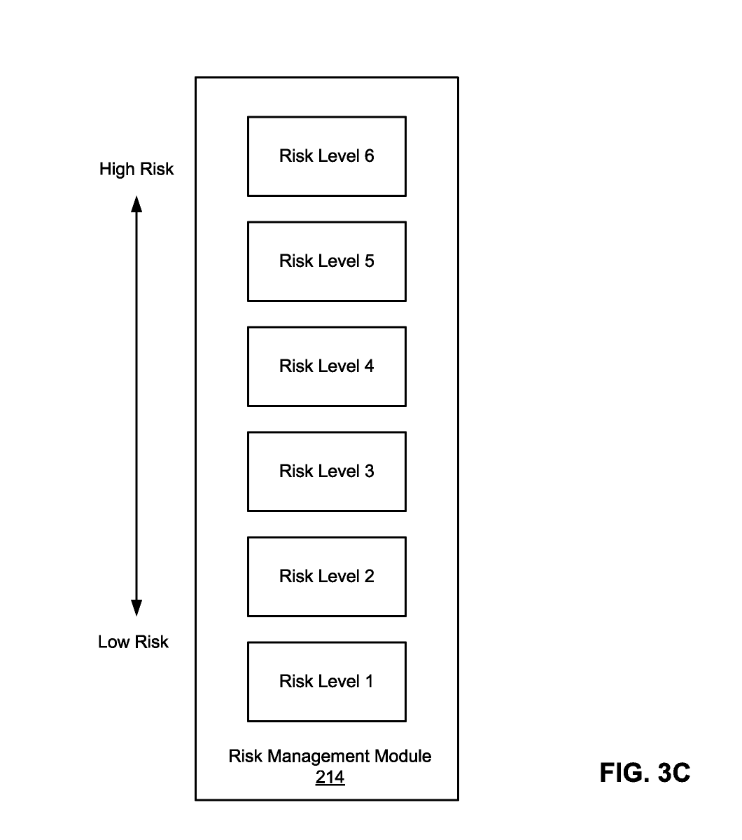

Order processing module 212 may associate user 114's following order with user 112. This process may also be referred to as an odds following process, in that user 114 follows user 112's future order based on the odds of winning (e.g., the winning probability) estimated for that future order. FIG. 3A illustrates an exemplary odds following process, according to a first embodiment. In FIG. 3A, user 114 may indicate following user 112's next order (Order A 302) by submitting a following order (Order B 304) to order processing module 212. As discussed above, Order B 304 may be an order specified by user 114, a preset order, or an automatically generated order based on user 114's risk tolerance level. Upon receiving Order B 304, order processing module may associate Order B 304 with user 112. For example, order processing module may establish an informational link between Order B 304 and user 112. When user 112 submits an order to order processing module 212. Order processing module 212 may determine whether the order includes a trading characteristic associated with the winning probability based on which Order B 304 is submitted. The trading characteristic may include the trading type, the trading product, the collection of the trading products, or other factors considered when the winning probability is estimated. For example, after user 114 follows user 112's next order on EURUSD based on its estimated winning probability, user 112 may trade other currency products, such as EURNZD, USDNZD, etc before submitting Order A 302 for exchanging EURUSD. Order processing module may ascertain the difference in the orders and may execute Order B 304 only when a triggering order containing the desired trading characteristic is detected (e.g., Order A 302 for exchanging EURUSD in the above example may constitute a triggering order). After a triggering order is detected, order processing module 212 may execute the following order (e.g., Order B 304) in synchronization with execution of the triggering order (e.g., Order A 302). For example, order processing may submit both orders at substantially the same time to exchange 132 through broker 123 (e.g., for Order A 302) and broker/trading software 126 (e.g., for Order B 304).

FIG. 3B illustrates another exemplary odds following process, according to a second embodiment. In FIG. 3B, user 112 may submit his/her trading orders directly to exchange 132 through broker 124 or trading software 122, without passing through order processing module 212. In this case, order processing module 212 may monitor the order status of user 112's trading account through, for example, broker/trading software interface 206. Once order processing module detects a triggering Order A 312 containing the desired trading characteristic, order processing module 212 may immediately submit Order B 314 to exchange 132. In some embodiments, order processing module 212 may employ high speed trading technique such that the delay between execution of Order A 312 and Order B 314 may be reduced to a negligent level (e.g., the execution price difference between Order A 312 and Order B 314 is minimal). In this way, user 112, often an experienced trader, may continue using any trading tool of his/her choice (e.g., user 112 may not be forced to use trading system 102 to conduct trading) while still allowing other users of trading system 102 to follow his/her order.

FIG. 3C a block diagram of an exemplary implementation of risk management module 214. As shown in FIG. 3C, risk management model 214 may include a plurality of risk levels. Each level may represent a degree of risk tolerance. For example, risk level 1 may represent the lowest degree of risk tolerance, and as the risk level becomes higher, the degree of risk tolerance may also increase. Each risk level may correspond to a combination of factors relating to the following order placed by a user. For example, with lower risk levels, a following order may not exceed a certain amount or a certain percentage of the account balance. Therefore, a user at risk level 1 may only be allow to place a following order of, for example, 1000 USD worth or less. In another example, loss may be capped to a certain amount of percentage when the risk level is low. Therefore, a user's holding of certain financial product may be sold automatically to prevent larger loss if the user is at a low risk level. On this other hand, higher risk level may allow a user more freedom to trade at will with fewer or no limitations.

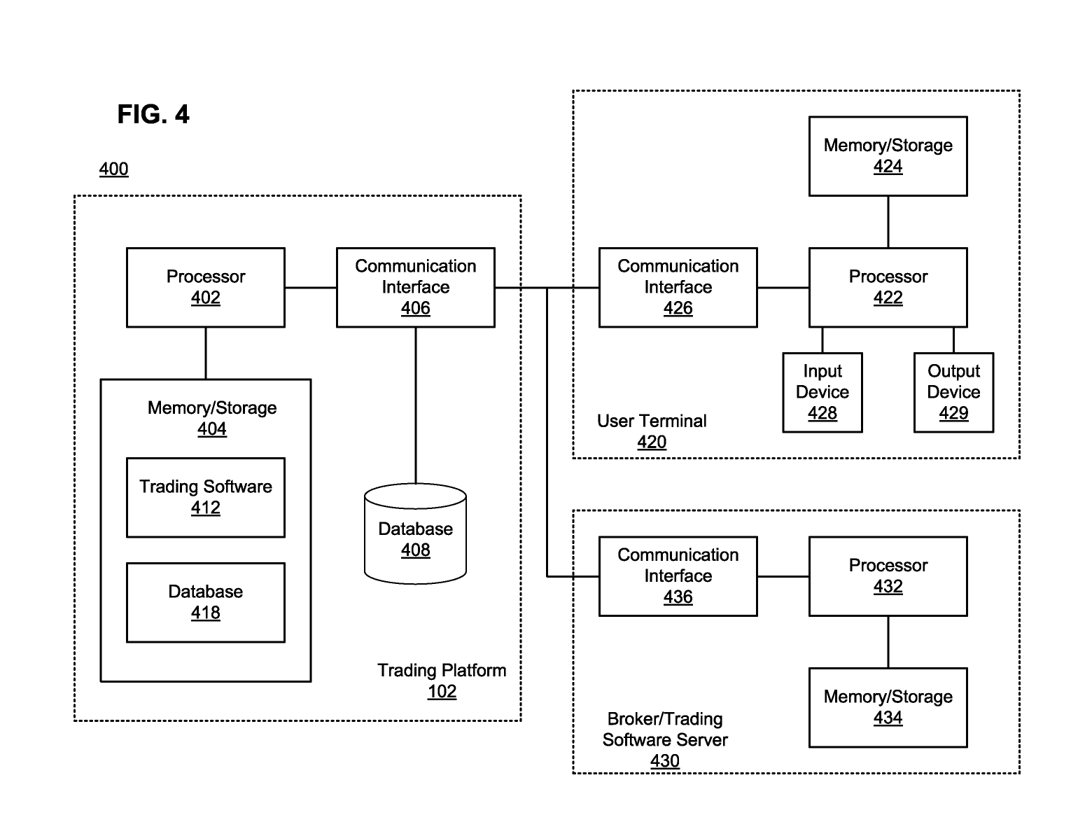

FIG. 4 illustrates an exemplary computer system 400 for implementing methods and systems consistent with the present disclosure. For example, computer system 400 may be used to implement online trading system 100 in FIG. 1. Further, computer system 400 may be used to perform the function of the modules discussed above.

As shown in FIG. 4, computer system 400 may include trading system 102, user terminal 420, and broker/trading software server 430. Trading system 102 may include a processor 402, which may be a general purpose processor, such as various known commercial CPUs. Processor 402 may interact with memory/storage 404 to implement the function of the modules described above. Memory/storage 404 may include volatile or non-volatile memory capable of storing instructions, as well as any data necessary to facilitate the disclosed modules. For example, Memory/storage 404 may include RAM, ROM, flash drive, hard drive, optical drive, semiconductor storage, etc. Memory/storage 404 may store trading software 412 that includes program and code to implement the function of the disclosed modules, as well as database 418 storing necessary data to facilitate the disclosed modules.

Processor 402 may also interact with a communication interface 406 to connect to user terminal 420, broker/trading software server 430, as well as database 408. Database 408 may include any cloud storage solutions that are not necessarily co-locate with processor 402 and memory/storage 404. Communication interface 406 may include wired or wireless communication devices to establish and maintain communication links between trading system 102 and other entities of trading system 100.

User terminal 420 may include a desktop computer, a laptop, a tablet, a mobile phone, and other personal computing devices. User terminal 420 may include a processor 422, a memory/storage 424, a communication interface 426, an input device 428 and an output device 429. Processor 422 may be a general purpose processor, such as a CPU, a mobile chip, etc. Memory/storage 424 may include volatile or non-volatile memory or storage device capable of storing instructions and data. Communication interface 426 may include wired or wireless communication devices to interact with trading system 102 and broker/trading software server 430. Processor 422 may interact with input device 428 (e.g., a keyboard, a mouse, a touch screen, a card reader, etc.) and output device 429 (e.g., a display, a printer, etc.). A user may interact with user terminal 420 using input device 428. Output device 429 may be used to display or print data reports produced from various modules. For example, input device 428 and output device 429 may be part of user interface 202.

Broker/trading software server 430 may be a server that used by broker 124 and/or trading software 122. Server 430 may include a processor 432, a memory/storage 434, and a communication interface 436. These components of server 430 may be similar to those of trading system 102.

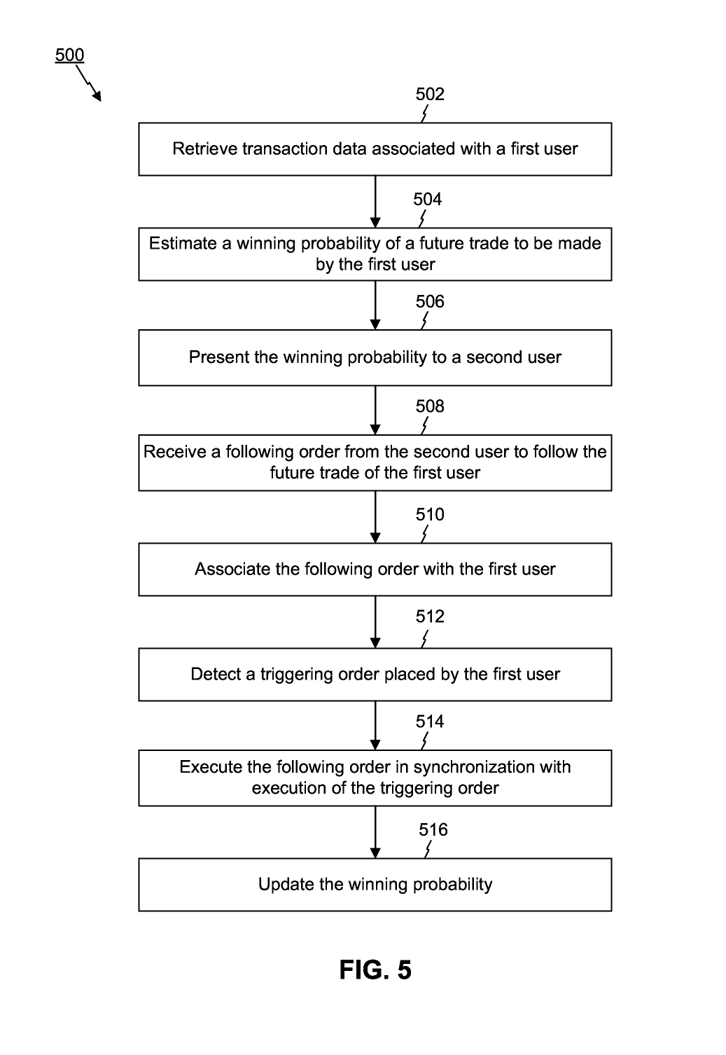

FIG. 5 is a flowchart of an exemplary online trading method. FIG. 5 includes a series of steps, some of which may be optional. At step 502, trading system 102 may retrieve transaction data associated with a first user (e.g., user 112) through broker/trading software interface 206 and store the transaction data in transaction database 208. At step 504, winning probability estimation module 210 may estimate a winning probability of a future trade (e.g., the next trade) to be made by the first user (e.g., user 112) based on transaction data stored in transaction database 208. At step 506, the estimated winning probability may be presented to a second user (e.g., user 114) through user interface 202. At step 508, order processing module 212 may receive a following order (e.g., Order B 304 or Order B 314) from the second user (e.g., user 114) to follow the future trade of the first user (e.g., user 112). At step 510, order processing module 212 may associate the following order (e.g., Order B 304 or Order B 314) with the first user (e.g., user 112). At step 512, order processing module may detect a triggering order (e.g., Order A 302 or Order A 312) placed by the first user (e.g., user 112). At step 514, order processing module 212 may execute the following order (e.g., Order B 304 or Order B 314) in synchronization with execution of the triggering order (e.g., Order A 302 or Order A 312). At step 516, wining probability estimation module 210 may update the winning probability based on updated transaction data (e.g., including the triggering order placed by the first user).

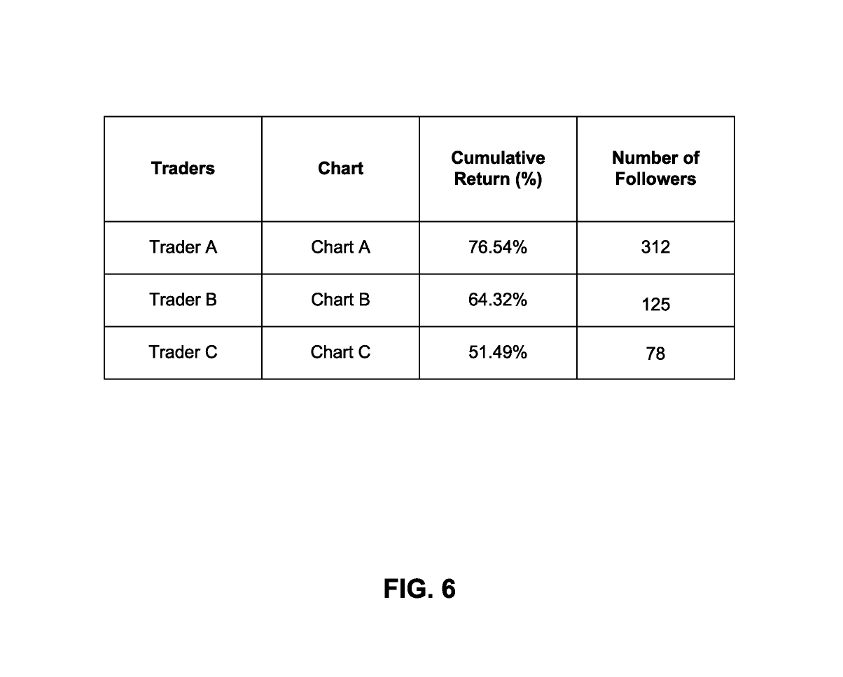

FIG. 6 illustrates an exemplary table for presenting trading information. Information of FIG. 6 may be presented to users of trading system 102 as Top N Traders based on the number of followers through user interface 202. As shown in FIG. 6, each row of the table may include the trader's ID, a performance chart, the cumulative return percentage, and the number of followers. A trader having a large number of followers may be a popular target to be followed by other users. The cumulative return percentage also provides an objective performance indicator to provide more insights to the users of the trading system 102.

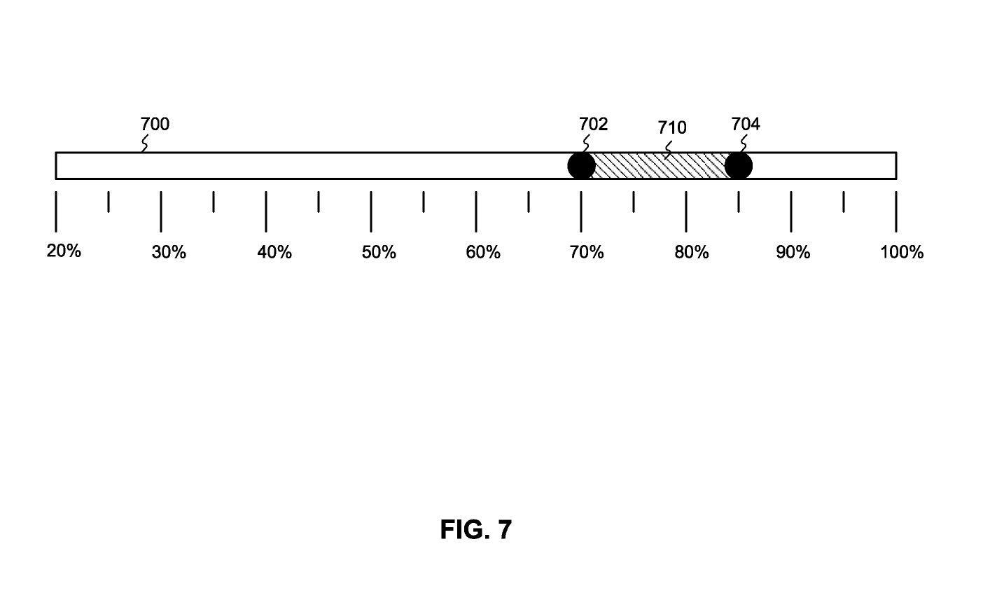

FIG. 7 illustrates an exemplary odds searching process. Odds searching may provide the users of trading system 102 a quick and intuitive way to identify a target trader to follow. The odd searching process may be carried out by odds search engine 216. For example, trading system 102 may retrieve a plurality of transaction data sets associated with a plurality of traders through broker/trading software interface 206, and wining probability estimation module 210 may then estimate, for each trader, a corresponding winning probability based on a corresponding transaction data set. For example, referring to FIG. 1, winning probability estimation module may estimate a winning probability for each of users 112 and 116. User 114 may then use an odds searching tool to identify the target trader to follow. Referring back to FIG. 7, user 114 may be presented with a winning probability bar 700 by user interface 202. On bar 700 the winning probabilities are marked using percentage values. User 114 may slide a lower limit indicator 702 and an upper limit indicator 704 to define a winning probability range 710. Then, user 114 may start searching all available traders having their winning probability falling within the winning probability range 710 (e.g., by click a button, not shown).

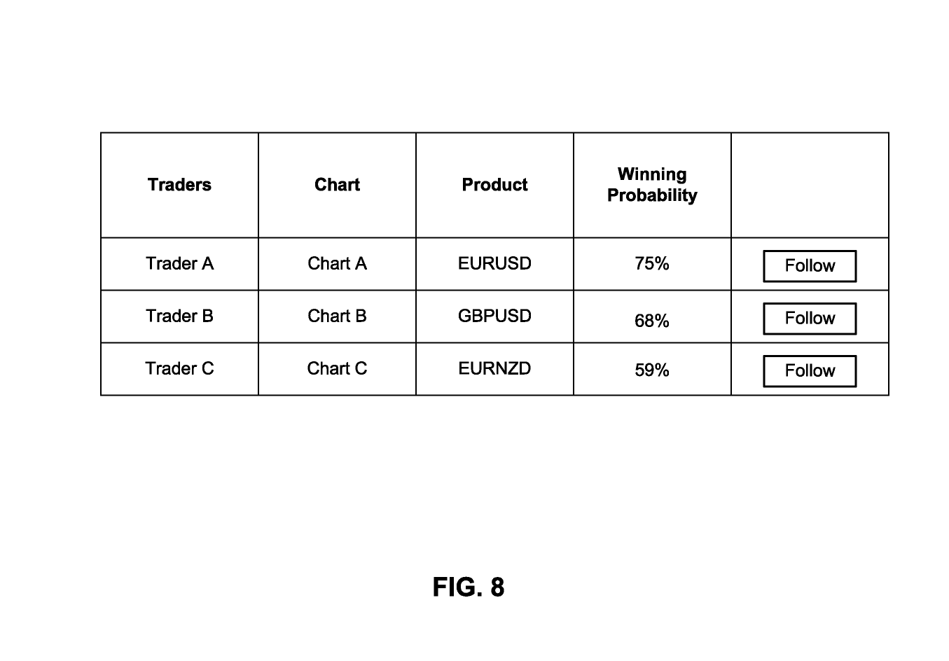

FIG. 8 illustrates an exemplary table for presenting winning probabilities. In some embodiments, FIG. 8 may be a search result following the odds searching process illustrated in FIG. 7. In other embodiments, FIG. 8 may be presented to the users of trading system 102 as “Today's Top Black Horse” or the like based on their estimated winning probabilities. In FIG. 8, each row of the table represents a trader's relevant trading information, including the trader's ID, a performance chart, the specific product to be traded by the trader, the winning probability of trading such product, and a “Follow” indicator. A user may click the “Follow” indicator to follow the next order to be placed by the chosen trader to trade the specific listed product. In some embodiment, after the following order is executed, order processing module 212 may dissociate the follower's future order from the trader that is followed. In this way, the follower only follows one specific order of a trader instead of any orders placed by the trader.

The specification has described systems and methods for online trading. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A computer-implemented online trading method, comprising:
retrieving transaction data indicating trading activities associated with a first user;
estimating, by a processor device, a winning probability of a future trade to be made by the first user based on the transaction data;
presenting, through a user interface, the winning probability to a second user;
receiving, through the user interface, a following order from the second user to follow the future trade of the first user;
associating, by the processor device, the following order with the first user;
detecting, by the processor device, a triggering order placed by the first user, the triggering order including a trading characteristic associated with the winning probability; and
executing the following order in synchronization with execution of the triggering order.

2. The method of claim 1, wherein retrieving the transaction data comprises retrieving the transaction data from a brokerage account of the first user.

3. The method of claim 1, wherein retrieving the transaction data comprises retrieving the transaction data from a trading software account of the first user.

4. The method of claim 1, wherein the transaction data comprise a history of trading transactions associated with the first user.

5. The method of claim 1, wherein estimating the winning probability comprises estimating a likelihood that a profit level resulting from the future trade is higher than a predetermined threshold.

6. The method of claim 1, wherein estimating the winning probability comprises:
identifying a subset of the transaction data associated with a particular trading type; and
estimating the winning probability based on the subset of the transaction data.

7. The method of claim 6, wherein the particular trading type is selected from a group consisted of: currency, stock, bond, commodity, future, option, and derivatives.

8. The method of claim 6, wherein the trading characteristic associated with the winning probability includes the trading type.

9. The method of claim 1, wherein estimating the winning probability comprises:
identifying a subset of the transaction data associated with a particular trading product; and
estimating the winning probability based on the subset of the transaction data.

10. The method of claim 9, wherein the trading characteristic associated with the winning probability includes the trading product.

11. The method of claim 1, wherein the following order includes the trading characteristic associated with the winning probability.

12. The method of claim 1, comprising:
dissociating the following order from the first user upon execution of the following order.

13. The method of claim 1, comprising:
retrieving a plurality of transaction data sets associated with a plurality of users, each transaction data set corresponding to one of the plurality of users;
estimating, for each of the plurality of users, a corresponding winning probability based on a corresponding transaction data set;
receiving a request from the second user indicating a range of winning probabilities;
searching, among the plurality of users, at least one user having a matching winning probability that is within the range; and
presenting the matching winning probability to the second user.

14. A trading system comprising:
a processor device operatively coupled to a memory device, wherein the processor device is configured to execute instructions stored in the memory device to perform operations comprising:
retrieving transaction data indicating trading activities associated with a first user;
estimating, by the processor device, a winning probability of a future trade to be made by the first user based on the transaction data;
presenting, through a user interface, the winning probability to a second user;
receiving, through the user interface, a following order from the second user to follow the future trade of the first user;
associating, by the processor device, the following order with the first user;
detecting, by the processor device, a triggering order placed by the first user, the triggering order including a trading characteristic associated with the winning probability; and
executing the following order in synchronization with execution of the triggering order.

15. The trading system of claim 14, wherein the operations comprise retrieving the transaction data from at least one of a brokerage account or a trading software account of the first user.

16. The trading system of claim 14, wherein the operations comprise estimating a likelihood that a profit level resulting from the future trade is higher than a predetermined threshold.

17. The trading system of claim 14, wherein the operations comprise:
identifying a subset of the transaction data associated with a particular trading type or a particular trading product; and
estimating the winning probability based on the subset of the transaction data.

18. The trading system of claim 17, wherein the trading characteristic associated with the winning probability includes the trading type or the trading product.

19. The trading system of claim 14, wherein the operations comprise:
retrieving a plurality of transaction data sets associated with a plurality of users, each transaction data set corresponding to one of the plurality of users;
estimating, for each of the plurality of users, a corresponding winning probability based on a corresponding transaction data set;
receiving a request from the second user indicating a range of winning probabilities;
searching, among the plurality of users, at least one user having a matching winning probability that is within the range; and
presenting the matching winning probability to the second user.

20. A non-transitory, computer-readable medium storing instructions that, when executed by a processor device, cause the processor device to perform operations comprising:
retrieving transaction data indicating trading activities associated with a first user;
estimating, by a processor device, a winning probability of a future trade to be made by the first user based on the transaction data;
presenting, through a user interface, the winning probability to a second user;
receiving, through the user interface, a following order from the second user to follow the future trade of the first user;
associating, by the processor device, the following order with the first user;
detecting, by the processor device, a triggering order placed by the first user, the triggering order including a trading characteristic associated with the winning probability; and
executing the following order in synchronization with execution of the triggering order.
